(19) United States
(12) Patent Application Publication
(10) Pub. No.: US 2009/0019678 A1
(43) Pub. Date: Jan. 22, 2009

(54) Intravenous tube organizer

(76) Inventor: Susan L. Taylor, Kokomo, IN (US)

Correspondence Address: INDIANO VAUGHAN LLP., SUITE 1300, ONE NORTH PENNSYLVANIA STREET, INDIANAPOLIS, IN, 46204, US

(21) Appl. No.: 12/218,428

(22) Filed: Jul. 15, 2008

Related U.S. Application Data
(60) Provisional application No. 60/961,124, filed on Jul. 19, 2007.

(51) Int. Cl. F16L 3/01

(52) U.S. Cl. 24/530

(57) ABSTRACT

A clip is provided that is especially well adapted for holding IV lines. The clip includes a first member and a second member. The first member defines a groove, and the second member defines a second groove substantially corresponding to the first groove of the first member. An axial member is also included. The first member and the second member are configured to rotate about the axial member.

### PRIORITY CLAIM

The instant application claims benefit of Susan Taylor, U.S. Provisional Patent No. 60/961,124, filed 19 Jul. 2007, which application is fully incorporated herein by reference.

### TECHNICAL BACKGROUND

The present invention generally relates to intravenous (IV) lines, and more particularly to holders for helping to hold and manage a plurality of IV lines

### BACKGROUND OF THE INVENTION

IV lines are typically small and flexible plastic tubes used to transfer fluids from a source into a needle or IV catheter that is positioned in the vein of a medical patient needing the fluids. Such fluids include medicine and liquid food.

It is only possible for IV lines to carry one fluid at a time. Therefore, depending on the number of fluids a patient needs at any given time, as many as five (5) or more different IV lines may necessarily be attached to a patient at the same time. When multiple IV lines are attached concurrently to a patient, the IV lines often become tangled. Tangled IV lines can be dangerous for patients and cause nurses to spend valuable time attempting both to untangle the lines and to maintain the lines in an untangled state.

One object of the present invention is to provide a device that will help medical personnel better organize and manage multiple IV lines.

### SUMMARY OF THE INVENTION

In accordance with the present invention, a clip is provided that comprises a first member and a second member. The first member defines a groove, and the second member defines a second groove substantially corresponding to the first groove of the first member. An axial member is also included. The first member and the second member are configured to rotate about the axial member.

Preferably, at least one of the first and second members includes one or more channel members that are attached thereto, and the axial member includes a spring that causes tension between the first member and the second member.

Additionally, the first and second members can each define concave surfaces, wherein the concave surfaces of at least one of the first and second members is rubberized. The first member can also include a first base and a handle.

The present invention provides a clasp-clip like device that attaches to a hospital bed railing or bed sheets and holds IV lines in a collected manner between the IV stand and the patient. The handles of the clip are designed with a unique “trough” where the line passes through while maintaining enough handle area that they can easily be squeezed together.

By clasping together the trough handles, the clip can be moved with the IV line lying in the trough. This provides one of the best benefits of the clip. This benefit being the device's ability to allow multiple IV tubes to remain collected or gathered while repositioning them. This is particularly helpful when the patient is being moved, repositioned, or transported.

Preferably, the clip base is uniquely rounded and rubberized. The rounded and rubberized base allows for universal gripping to a variety of bed railings and other places on the bed. By providing a trough for the tubing to lay in, the clip can be used to reposition the tubing where it is most useful and convenient for the nurse and patient.

The clip is designed and intended to keep the tubing up off the floor and collected at the bed, thereby reducing the potential entanglement and constriction of the lines. Moreover, the clip can keep the lines up and away from the patient, thereby reducing the risk of the IV lines being pulled out of the patient.

The above-mentioned and other features of this invention, and the manner of attaining them, will become more apparent and the invention itself will be better understood by reference to the following description of the preferred embodiments of the invention taken in conjunction with the accompanying drawings.

### BRIEF DESCRIPTION OF THE DRAWINGS

FIG. 1 is a perspective view of one embodiment of the clip of the present invention;

FIG. 2A is a perspective top view of a first member of the clip of the present invention;

FIG. 2B is a perspective bottom view of a second member of the clip of the present invention;

FIG. 2C is a perspective side view of the second member of the clip of the present invention; and

FIG. 3 is a view of one embodiment of the handle of the second member of the clip of the present invention.

Corresponding reference characters indicate corresponding parts throughout the several views. Although the drawings represent embodiments of the present invention, the drawings are not necessarily to scale and certain features may be exaggerated in order to better illustrate and explain the present invention.

### DETAILED DESCRIPTION OF THE PRESENT INVENTION

The embodiments disclosed below are not intended to be exhaustive or limit the invention to the precise forms disclosed in the following detailed description. Rather, the embodiments are chosen and described so that others skilled in the art may utilize their teachings. The use of the terms IV “lines” and IV “tubes” will be used interchangeably throughout this application.

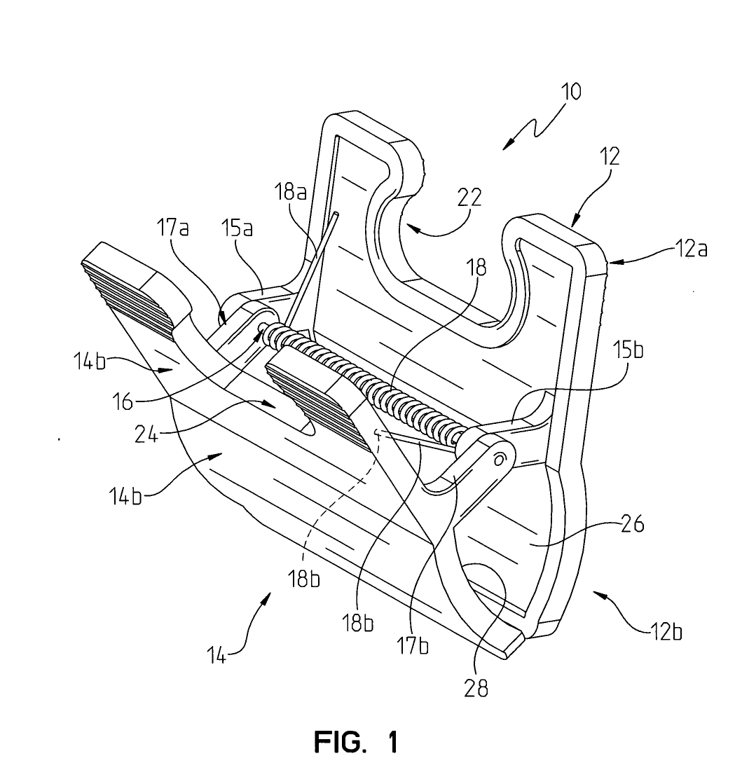

As shown in FIG. 1, clip 10 of the present invention includes a first member 12 and a second member 14. First member 12 includes a first handle 12a and a first base 12b. First handle 12a defines a first trough 22. First trough 22 is configured to hold IV lines in a collected manner. First base 12b contains a first inner concave surface 26. Second member 14 includes second handle 14a and second base 14b. Second handle 14a defines a second trough 24, which substantially corresponds to first trough 22. Second base 14b contains second inner concave surface 28 that substantially corresponds to first inner concave surface 26. While first trough 22 and second trough 24 are large enough to hold multiple IV lines, enough of the respective areas of first handle 12a and second handle 14a are maintained to allow handles 12a, 14a to be manually clasped together by one desiring to use clip 10.

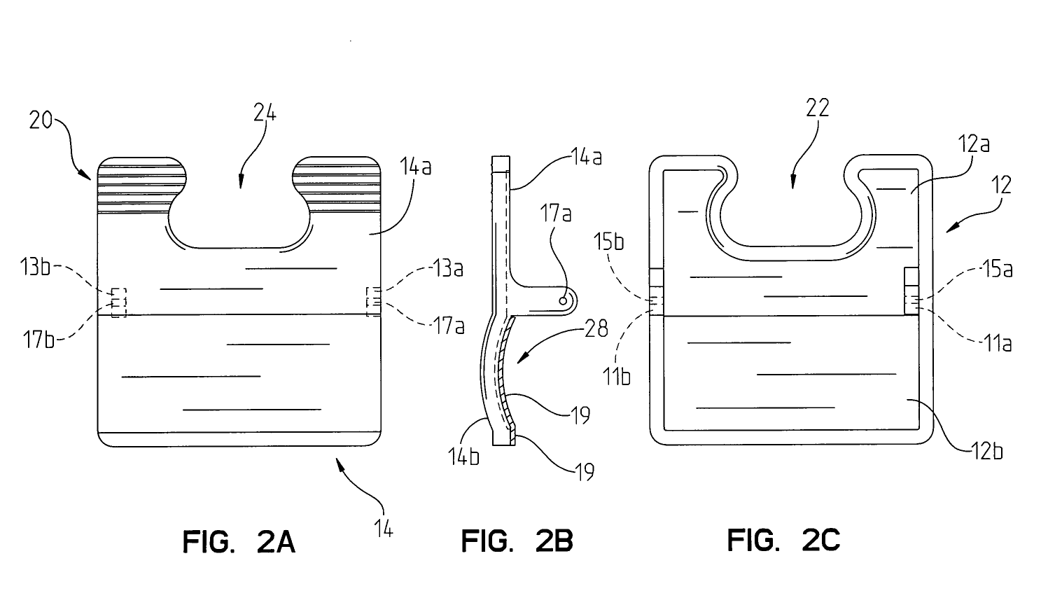

First member 12 includes prongs 11a, 11b on the underside of first handle 12a. As also shown in FIG. 2A, prong 11a defines opening 15a and prong 11b defines opening 15b. Second member 14 includes prongs 13a, 13b on the underside of second handle 14a. As shown in FIG. 2B, prong 13a defines an opening 17a and prong 13b defines an opening 17b. When first member 12 is positioned on top of second member 14, openings 15a, 15b, 17a, 17b align with each other. Axial member 16 (FIG. 1) extends through respective openings 15a, 15b, 17a, 17b of respective prongs 11a, 11b, 13a, 13b, thereby enabling first member 12a and second member 14a to rotate about the axis created by axial member 16.

As spring 18 is coiled about axial member 16, spring 18 includes extended ends 18a, 18b. Extended ends 18a, 18b extend to and maintain contact with first handle 12a and second handle 14a, respectively, thereby creating a constant tension between first handle 12a and second handle 14a. This tension normally biases base 12b into engagement with base 14B. The handles 12a, 14a can be grasped to exert force against the bias of spring 18 to pivot handles 12, 14 about the axis of axle 16, to cause base members 12b, 14b to move away from each other and out of engagement to thereby facilitate the relative movement of the clip 10 and the IV lines. The handles 12a, 14a can be clasped so that clip 10 can be moved with the IV line lying in respective troughs 22, 24.

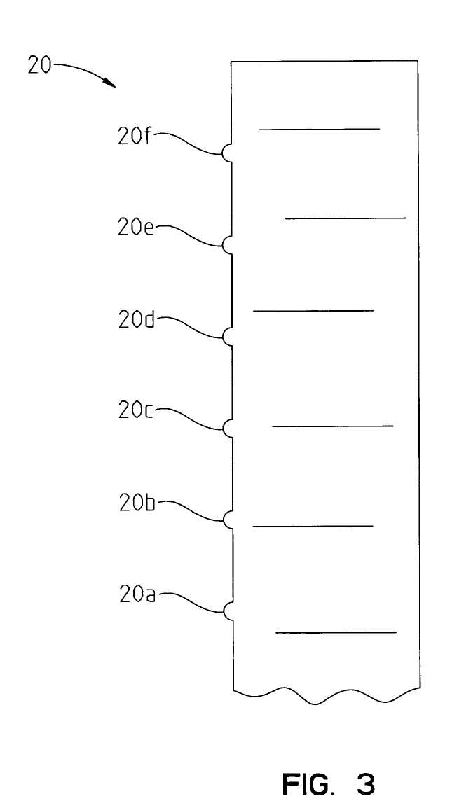

FIG. 2B shows a bottom view of second member 14. As shown in this figure, and as is illustrated in FIG. 2C, in one embodiment of the present invention, the bottom of second handle 14a contains a plurality of channel members 20. These are ridges in the handle carved in the plastic for better gripping. Shown in greater detail in FIG. 3, channel members 20a-20f may be attached to the surface of second handle 14a. In other embodiments, channel members 20a-20f may be formed within second handle 14a itself. Channel members 20a-20f are used to individually contain IV lines so as to better organized them as they are positioned within troughs 22, 24. The present invention also contemplates providing a plurality of channel members 20 on or within first handle 12a.

Again referring to FIG. 2C, a select portion or all of inner concave surface 28 (as well as inner concave surface 26, which is not shown in FIG. 2C) may include a rubberized strip 19 or other means of providing friction to surfaces 28, 26. Rubberized strip 19 or other friction means better enables clip 10 to clamp more securely to bed railings and sheets.

In one embodiment of the present invention, clip 10 is made of a synthetic or naturally organic material such as plastic. In other embodiments of the present invention, clip 10 may be made of rubber and wood.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed:

1. A clip comprising:
a first member, said first member defining a first groove;
a second member, said second member defining a second groove substantially corresponding to the first groove of said first member; and
an axial member, said first member and said second member configured to rotate about said axial member.

2. The clip of claim 1 wherein at least one of said first and second members includes one or more channel members attached thereto.

3. The clip of claim 1 wherein at least of said first and second members defines one or more channel members.

4. The clip of claim 1 wherein said axial member includes a spring, said spring causing tension between said first member and said second member.

5. The clip of claim 1 wherein said first and second members each defines a concave surface.

6. The clip of claim 5 wherein the concave surface of at least one of said first and second members is rubberized.

7. The clip of claim 1 wherein said first member includes a first base and a first handle.

8. The clip of claim 7 wherein the first handle defines the first groove.

9. The clip of claim 7 wherein said second member includes a second base and a second handle.

10. The clip of claim 9 wherein the second handle defines the second groove.

11. A clip for holding a plurality of fluid lines comprising
a first member, the first member including a concave surface, at least one channel member, a first base, and a first groove like handle,
a second member, the second member including a concave surface, at least one channel member, a first base and a first groove like handle; and
an axial member, the axial members including a spring for exerting tension between the first member and the second member
wherein the first member and the second member are configured to rotate about the axial member.

12. The clip of claim 11 wherein the concave surface of at least one of the first and second members is rubberized.
